(19) United States
(12) Patent Application Publication
(10) Pub. No.: US 2006/0217098 A1
(43) Pub. Date: Sep. 28, 2006

(54) System for reducing power consumption in a local oscillator

(76) Inventors: Jeffrey Karl Anderson, Irvine, CA (US); Jeffrey M. Zachan, Aliso Viejo, CA (US); Geoffrey Hatcher, Newport Beach, CA (US)

Correspondence Address: SMITH FROHWEIN TEMPEL GREENLEE BLAHA, LLC, P.O. BOX 88148, ATLANTA, GA, 30356, US

(21) Appl. No.: 11/086,107

(22) Filed: Mar. 22, 2005

(51) Int. Cl. H04B 1/06; H04B 1/16; H04B 7/00

(52) U.S. Cl. 455/255; 455/343.1

(57) ABSTRACT

A system for reducing power consumption of a local oscillator (LO) chain is disclosed. Embodiments of the system for reducing power consumption of a local oscillator chain include adjusting a bias control signal to the local oscillator depending on a noise parameter of the local oscillator. In one embodiment, the measured receive signal level is analyzed to derive an appropriate local oscillator bias control signal, which minimizes power consumption in the local oscillator.

### BACKGROUND OF THE INVENTION

1. Field of the Invention

This invention relates generally to minimizing power consumption in an electronic device. More particularly, the invention relates to minimizing power consumption of a local oscillator (LO) by controlling the bias supply to the LO based on a noise parameter of the local oscillator.

2. Related Art

With the increasing availability of efficient, low cost electronic modules, one-way and two-way mobile communication systems are becoming more and more widespread. One-way communications devices, such as pagers, and remote monitoring devices, such as those implanted in animals or located at remote locations, provide tracking and performance data. Two-way communication devices, such as cellular telephones and two-way radios, provide communication capability to an ever increasing number of users.

There are many variations of communication schemes in which various frequencies, transmission schemes, modulation techniques and communication protocols are used to provide two-way voice and data communications in a handheld, telephone-like communication handset, also referred to as a portable transceiver. The different modulation and transmission schemes each have advantages and disadvantages.

As these mobile communication systems have been developed and deployed, many different standards have evolved, to which these systems must conform. For example, in the United States, many portable communications systems comply with the IS-136 standard, which requires the use of a particular modulation scheme and access format. In the case of IS-136, the modulation scheme is narrow band offset π/4 differential quadrature phase shift keying (π/4—DQPSK), and the access format is TDMA.

In Europe, the global system for mobile communications (GSM) standard requires the use of the gaussian minimum shift keying (GMSK) modulation scheme in a narrow band TDMA access environment, which uses a constant envelope modulation methodology.

Furthermore, in a typical GSM mobile communication system using narrow band TDMA technology, a GMSK modulation scheme supplies a low noise phase modulated (PM) transmit signal to a non-linear power amplifier, usually directly from an oscillator. In such an arrangement, a highly efficient, non-linear power amplifier can be used thus allowing efficient modulation of the phase-modulated signal and minimizing power consumption. Because the modulated signal is supplied directly from an oscillator, the need for filtering, either before or after the power amplifier, is minimized. Further, the output in a GSM transceiver is a constant envelope (i.e., a non time-varying amplitude) modulation signal, which is amenable to non-linear amplification. The relatively high power output from the oscillator allows lower gain amplification, which typically allows for more efficient and lower noise power amplifiers to be employed.

Regardless of the type of modulation methodology employed, virtually all of these portable communication devices operate using a limited power source, such as a battery. It is desirable to minimize the amount of power consumed by the portable communication device so that the operating time of the portable communication device may be maximized.

One of the systems within the portable transceiver that consumes a significant amount of power is an oscillator that is used to develop a signal at a particular frequency that is used to convert the transmit signal from baseband to the proper transmit frequency, and to convert the frequency of a received signal to a baseband signal. In a receive-only device, the oscillator is used only to downconvert the received signal. The signal generated by the oscillator is typically referred to as a “local oscillator” signal, or “LO” signal. Such an oscillator may be what is referred to as a “voltage controlled oscillator,” or “VCO.” A VCO is typically designed such that the desired output frequency is predominately dependent on the voltage applied to a “tuning port.” In a typical implementation of a VCO, the capacitance (and hence resonant frequency) of a voltage-variable semiconductor element is altered by adjusting the tuning port voltage. For a given LO chain design, the sideband noise performance is typically a function of the quiescent, or bias power consumed by the circuit. Increased bias power generally increases gain or input power to sub-circuits that follow the oscillator or decreases the slew rate, typically reducing the effect of additive noise. Unfortunately, as the level of the bias signal increases, so does the amount of power consumed by the electronic device. The tradeoff in such an implementation is added sideband noise (via what is referred to as “reciprocal mixing”) versus reduced power consumption.

In the receive portion of a portable transceiver, or a one-way “receive-only” communication device, a local oscillator is used to develop an LO signal that is used to downconvert the received signal to a baseband signal, from which the information contained in the signal may be extracted. This may be a one-step process, as in the case of a so-called “direct conversion receiver,” or may be a multiple step process involving converting the received signal to an “intermediate frequency (IF)” prior to downconverting the received signal to baseband. The multiple step process may include one or more intermediate downconverted frequencies, or a high-speed analog-to-digital converter (ADC).

Regardless of the system used to downconvert the received signal to a baseband signal, when operating in many communication systems, the portable transceiver is expected to meet stringent standards. For example, when operating in the GSM communication system, the receiver in the portable transceiver must be able to receive, downconvert, and decode the desired signal in the presence of interfering signals, referred to sometimes as “blocking” signals. A blocking signal causes sideband noise to be translated into the desired receive frequency band, effectively raising the noise floor of the receiver, thus degrading the signal-to-noise (SNR) in the receiver and making it difficult to decode the desired signal. If the blocking signal is a sine wave with no noise or modulation, then the nominal frequency of the LO and any LO phase noise will modulate the blocking signal. In the downconverted signal path, the blocking signal will appear at the frequency determined by the nominal LO frequency. In addition, phase noise from the LO is superimposed onto the blocking signal in the downconverted signal path. Some of this phase noise will appear in the desired signal frequency, resulting in “reciprocal mixing.” If the blocking signal includes modulation or noise, then this will combine with the effect from the LO phase noise. The effect of the interference will depend on the strength of the desired signal, the relative strength of the blocking signal, the thermal noise floor of the receiver, and the degree of phase noise present on the LO.

One of the GSM standard tests require a blocking signal to be introduced to the portable transceiver approximately 3 megahertz (MHz) distant from the desired signal, and the receiver must be able to decode the desired signal. One manner of ensuring that the receiver can decode the desired signal is to increase the level of the bias signal to the LO chain such that the noise degradation due to LO phase noise is negligible.

However, during some operating circumstances, the desired receive signal is sufficiently strong such that the phase noise added by the LO will have minimal impact, thereby providing the receiver a high SNR. In such a circumstance, the LO may be able to operate the receiver using significantly less bias signal strength than that required to pass the “blocker signal” test described above, or when trying to receive a relatively weak receive signal.

Therefore it would be desirable to reduce the power consumption of the LO when the receive signal strength is high, while increasing the power to the LO when the receive signal is weak.

### SUMMARY

Embodiments of the system for controlling the bias power supplied to a local oscillator (LO) chain located in a portable communication device, comprise a portable communication device including a transmitter and a receiver, a receive signal strength determination element located in the receiver, and a local oscillator power control element responsive to the receive signal strength determination element. The local oscillator power control element is configured to supply a bias control signal to a local oscillator, the bias control signal level determined by the relative signal strength of the receive signal.

Related methods of operation are also provided. Other systems, methods, features, and advantages of the invention will be or become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE FIGURES

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views.

FIG. 1 is a block diagram illustrating a simplified portable transceiver including ths system for reducing local oscillator power consumption.

FIG. 2 is a block diagram illustrating a receive signal strength indicator (RSSI) element.

FIG. 3 is a block diagram illustrating an embodiment of the system for reducing LO power consumption of FIG. 1.

FIG. 4 is a flowchart illustrating the operation of an embodiment of the system for reducing LO power consumption.

FIG. 5 is a flowchart illustrating the operation of an alternative embodiment of the system for reducing LO power consumption.

FIG. 6 is a graphical representation of the effect of the system for reducing LO power consumption.

### DETAILED DESCRIPTION

Although described with particular reference to a portable transceiver, the system for reducing LO power consumption can be implemented in any system that uses a local oscillator to translate in frequency, a radio signal.

The system for reducing LO power consumption can be implemented in software, hardware, or a combination of software and hardware. In a preferred embodiment, the system for reducing LO power consumption may be implemented using a combination of hardware and software. The hardware can be implemented using specialized hardware elements and logic. The software portion of the system for reducing LO power consumption can be stored in a memory and be executed by a suitable instruction execution system (microprocessor).

The hardware implementation of the system for reducing LO power consumption can include any or a combination of the following technologies, which are all well known in the art: a discrete logic circuit(s) having logic gates for implementing logic functions upon data signals, an application specific integrated circuit having appropriate logic gates, a programmable gate array(s) (PGA), a field programmable gate array (FPGA), etc.

The software of the system for reducing LO power consumption comprises an ordered listing of executable instructions for implementing logical functions, and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

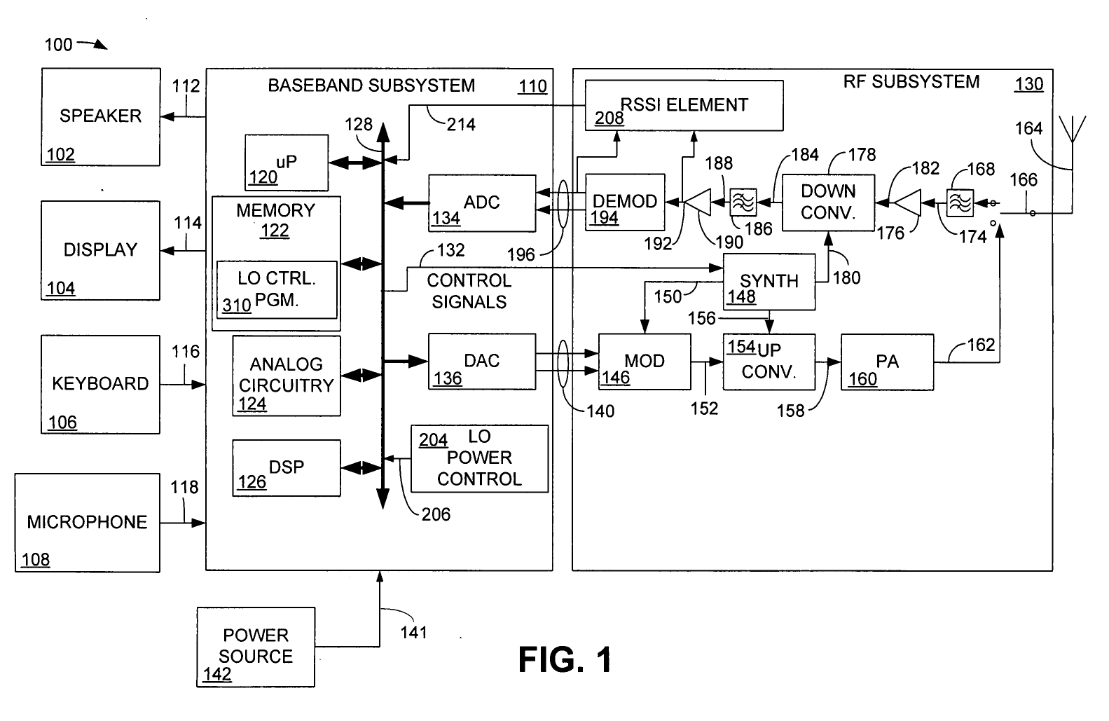

FIG. 1 is a block diagram illustrating a simplified portable transceiver 100 including the system for reducing LO power consumption. The portable transceiver 100 shown in FIG. 1 is a simplified depiction of a portable transceiver and may include a variety of transceiver architectures. For example, the portable transceiver 100 may be a transceiver that implements signal upconversion and downconversion using one or more intermediate frequencies (IF) or may include a direct launch transmitter and a direct conversion receiver in which the baseband transmit signals are converted directly to radio frequency (RF) transmit levels and in which RF receive signals are converted directly to baseband, referred to as a direct conversion receiver (DCR). Furthermore, the portable transceiver 100 may be one in which one or more local oscillators are used for both transmit and receive (as in the case of a DCR) or in which individual LOs are used for transmit and receive operation.

The portable transceiver 100 includes speaker 102, display 104, keyboard 106, and microphone 108, all connected to baseband subsystem 110. A power source 142, which may be a direct current (DC) battery or other power source, is also connected to the baseband subsystem 110 via connection 141 to provide power to the portable transceiver 100. In a particular embodiment, portable transceiver 100 can be, for example but not limited to, a portable telecommunication handset such as a mobile/cellular-type telephone. Speaker 102 and display 104 receive signals from baseband subsystem 110 via connections 112 and 114, respectively, as known to those skilled in the art. Similarly, keyboard 106 and microphone 108 supply signals to baseband subsystem 110 via connections 116 and 118, respectively. Baseband subsystem 110 includes microprocessor (NP) 120, memory 122, analog circuitry 124, and digital signal processor (DSP) 126 in communication via bus 128. Bus 128, although shown as a single bus, may be implemented using multiple busses connected as necessary among the subsystems within baseband subsystem 110. Microprocessor 120 and memory 122 provide the signal timing, processing and storage functions for portable transceiver 100. Analog circuitry 124 provides the analog processing functions for the signals within baseband subsystem 110. Baseband subsystem 110 provides control signals to radio frequency (RF) subsystem 130 via connection 132, and particularly, to the synthesizer 148 to be described below. Although shown as a single connection 132, the control signals may originate from DSP 126 or from microprocessor 120, and are supplied to a variety of points within RF subsystem 130. It should be noted that, for simplicity, only the basic components of portable transceiver 100 are illustrated herein.

Baseband subsystem 110 also includes analog-to-digital converter (ADC) 134, digital-to-analog converter (DAC) 136, and LO power control element 204. The ADC 134, DAC 136 and the LO power control element 204 also communicate with microprocessor 120, memory 122, analog circuitry 124 and DSP 126 via bus 128. DAC 136 converts the digital communication information within baseband subsystem 110 into an analog signal for transmission to RF subsystem 130 via connection 140. Connection 140, while shown as two directed arrows, includes the information that is to be transmitted by RF subsystem 130 after conversion from the digital domain to the analog domain.

When portions of the system for reducing LO power consumption are implemented in software, the memory 122 also includes LO control program 310. The LO control program 310 is generally stored in the memory 122 and executed in the microprocessor 120 or in another device or processor. For example, the LO control program 310 may also be executed by the DSP 126. As will be described below, in one embodiment of the system for reducing LO power consumption, a receive signal strength indicator (RSSI) element 208, to be described below, determines the relative power level of the signal received by the portable transceiver 100. The RSSI element 208 communicates the power level information to the LO power control element 204 via the bus 128. Based on the received power level and the signal-to-noise ratio (SNR) of the received signal, the LO power control element 204 determines an appropriate level to which to set the LO bias control via connection 132, thus adjusting the power consumed by various elements in the LO chain, while maintaining adequate signal-to-noise ratio in the receiver. Generally, the level of the LO bias control is set to the lowest level that will provide an acceptable signal-to-noise ratio in the receiver. In an alternative embodiment of the system for reducing LO power consumption, the LO control program 310 determines the appropriate bias control level to be applied to a LO located in the synthesizer 148. The LO power control element 204 implements the command from the LO control program 310 and sends a control signal via connection 132 to control the bias level, and therefore, the power consumption, of the LO in the synthesizer 148. In yet another embodiment, the LO bias level may be controlled by a signal supplied by a base station with which the portable transceiver 100 may be communicating, based on RSSI information provided by the mobile transceiver.

RF subsystem 130 includes modulator 146, which, after receiving a frequency reference signal, also called a “local oscillator” signal, or “LO,” from the synthesizer 148 via connection 150, modulates the received analog information and provides a modulated signal via connection 152 to upconverter 154. In a constant envelope modulation methodology, the modulated transmit signal generally includes only phase information. In a variable envelope modulation system, the modulated transmit signal may include both phase and amplitude information. Upconverter 154 also receives a frequency reference signal (LO signal) from synthesizer 148 via connection 156. The synthesizer 148 determines the appropriate frequency to which the upconverter 154 upconverts the modulated signal on connection 152. Depending on the implementation, the upconverter 154 may upconvert the modulated signal to an intermediate frequency prior to upconversion to an RF frequency. In other systems, the upconverter 154 may upconvert the modulated signal directly to an RF frequency. Further, depending on the modulation and upconversion methodology, various filters may be employed, but are omitted from FIG. 1 for simplicity.

Upconverter 154 supplies the modulated signal via connection 158 to power amplifier 160. Power amplifier 160 amplifies the modulated signal on connection 158 to the appropriate power level for transmission via connection 162 to antenna 164. Illustratively, the switch 166 controls whether the amplified signal on connection 162 is transferred to antenna 164 or whether a received signal from antenna 164 is supplied to filter 168. The operation of switch 166 is controlled by a control signal from baseband subsystem 110 via connection 132. Alternatively, the switch 166 may be replaced by a filter pair (e.g., a duplexer) that allows simultaneous passage of both transmit signals and receive signals, as known in the art.

Although omitted for simplicity, a portion of the amplified transmit signal energy on connection 162 may be supplied to a power control element to control the output power level of the signal to be transmitted.

A signal received by antenna 164 is directed to receive filter 168. Receive filter 168 filters the received signal and supplies the filtered signal on connection 174 to low noise amplifier (LNA) 176. Receive filter 168 is a band pass filter, which passes all channels of the particular cellular system in which the portable transceiver 100 is operating. As an example, for a 900 MHz GSM system, receive filter 168 would pass all frequencies from 935.2 MHz to 959.8 MHz, covering all 124 contiguous channels of 200 kHz each. The purpose of this filter is to reject all frequencies outside the desired region. LNA 176 amplifies the comparatively weak signal on connection 174 to a level at which downconverter 178 can translate the signal from the transmitted frequency to an IF frequency. Alternatively, the functionality of LNA 176 and downconverter 178 can be accomplished using other elements, such as, for example but not limited to, a low noise block downconverter (LNB).

Downconverter 178 receives a frequency reference signal, also called a “local oscillator” signal, or “LO,” from synthesizer 148, via connection 180. The LO signal instructs the downconverter 178 as to the proper frequency to which to downconvert the signal received from LNA 176 via connection 182. The signal may first be downconverted to an intermediate frequency or IF. Downconverter 178 sends the downconverted signal via connection 184 to channel filter 186, also called the “IF filter.” The channel filter 186 filters the downconverted signal and supplies it via connection 188 to amplifier 190. The channel filter 186 selects the one desired channel and rejects all others. Using the GSM system as an example, only one of the 124 contiguous channels is actually to be received. After all channels are passed by receive filter 168 and downconverted in frequency by downconverter 178, only the one desired channel will appear nominally at the center frequency of channel filter 186. The synthesizer 148, by controlling the local oscillator frequency supplied on connection 180 to downconverter 178, determines the selected channel. Amplifier 190 amplifies the received signal and supplies the amplified signal via connection 192 to demodulator 194. Demodulator 194 recovers the transmitted analog information and supplies a signal representing this information via connection 196 to ADC 134. ADC 134 converts these analog signals to a digital signal at baseband frequency and transfers the signal via bus 128 to DSP 126 for further processing. As an alternative, the downconverted carrier frequency (IF frequency) at connection 184 may be nominally 0 Hz, in which case the receiver is referred to as a “direct conversion receiver.” In such a case, the channel filter 186 is implemented as a low pass filter, and the demodulator 194 may be omitted.

In one embodiment, the system for reducing LO power consumption includes an RSSI element 208. The RSSI element 208 receives the output of the amplifier 190 via connection 212, or as will be described below, the output of the demodulator 194, and determines the relative power level of the received signal. The RSSI element 208 derives a baseband RSSI signal representative of the power level of the received signal, and sends the baseband RSSI signal to the baseband subsystem 110 via connection 214. The baseband RSSI signal is processed by the LO power control element 204, which develops a control signal that is delivered via connection 132 to the local oscillator within the synthesizer 148. In this embodiment, the control signal sent to the local oscillator is dependent on the relative power level of the received signal so that the level of the bias signal supplied to the LO may be reduced when the received power level is relatively high.

The amount of bias power consumed by the LO chain is dependent on a noise parameter of the receiver. Noise degradation occurs due to the presence of a blocking signal and reciprocal mixing in the local oscillator. The following inputs, outputs and system properties are assumed:

Inputs:

S desired signal, dBm.

N thermal noise, dBm/BWn.

B blocker or interferer at a particular offset, dBm.

Outputs:

So desired downconverted signal, dBm.

No downconverted+receiver noise, dBm.

System properties:

BWn equivalent noise bandwidth of the receiver, kHz.

BWndB equivalent noise bandwidth of the receiver, dB.

BPF passive preselector band pass filter loss, dB.

NF noise figure of the receiver, excluding BPF

G receiver gain chosen for given antenna input level (=G1+G2+ . . . +Gk), dB.

D allowable degradation in signal to noise ratio, dB.

PHI phase noise of LO at a particular frequency offset, dBc/Hz.

Excluding the effects of reciprocal mixing, the signal to noise ratio at the receiver output is So−No=(S−BPF+G)−(N+G+NF)=(S−BPF)−(N+NF) and a blocking signal is assumed to be rejected by the receiver intermediate or low-pass filter. For a given So−No degradation, the receiver output So−No is So−No=(S−BPF)−(N+NF+D).

The phase noise and thermal noise will add at the output, so the factor (N+NF+D) is expressed in linear units as10ˆ((N+NF+D)/10)=10ˆ((N+NF)/10+10ˆ((B−BPF+PHI)/10), which is then solved for PHI [dBc/Hz]. A typical AGC receiver has a minimum NF of 3.5 dB at the lowest input antenna input levels, and a conservative BPF loss of 3.5 dB.

Non-linear effects such as gain compression are not shown above. If the small signal gain is reduced, the allowable degradation, D, will be reduced to maintain a sufficient SNR. Additionally, if small signal gain is less than the large signal gain of the blocking signal, then the phase noise modulated onto the blocker signal will be higher relative to the desired signal. However, as the desired signal input increases, the AGC settings will provide a higher input power, reducing these effects. Regardless, the factor D should be budgeted for the non-linear effects at low antenna inputs. For example, if D=4 dB, NF=3.5 dB, and BPF=3.5 dB, G=94 dB, and desired antenna signal is −100 dBm, then a phase noise at 3 MHz offset of −139.2 dBc/Hz provides 10 dB SNR at baseband, excluding non-linear effects.

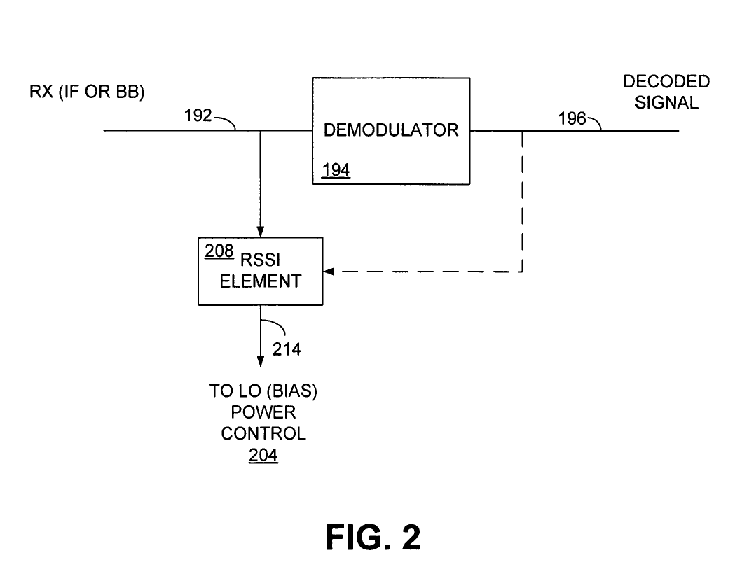

FIG. 2 is a block diagram illustrating the manner in which the received signal strength indicator (RSSI) signal is generated. The receive signal on connection 192 that is supplied to the demodulator 194 is also supplied to the RSSI element 208. The RSSI element 208 develops a received signal strength indicator signal in accordance with elements and algorithms that are known in the art. The output of the RSSI element 208 on connection 214 is supplied to the LO power control element 204. In one embodiment, the LO power control element 204 develops a control signal, based on the level of the RSSI signal, that is used to control the bias supplied to the various element in the LO chain, as will be described below. Alternatively, the output of the demodulator 194 on connection 196 can be used as the input to the RSSI element 208.

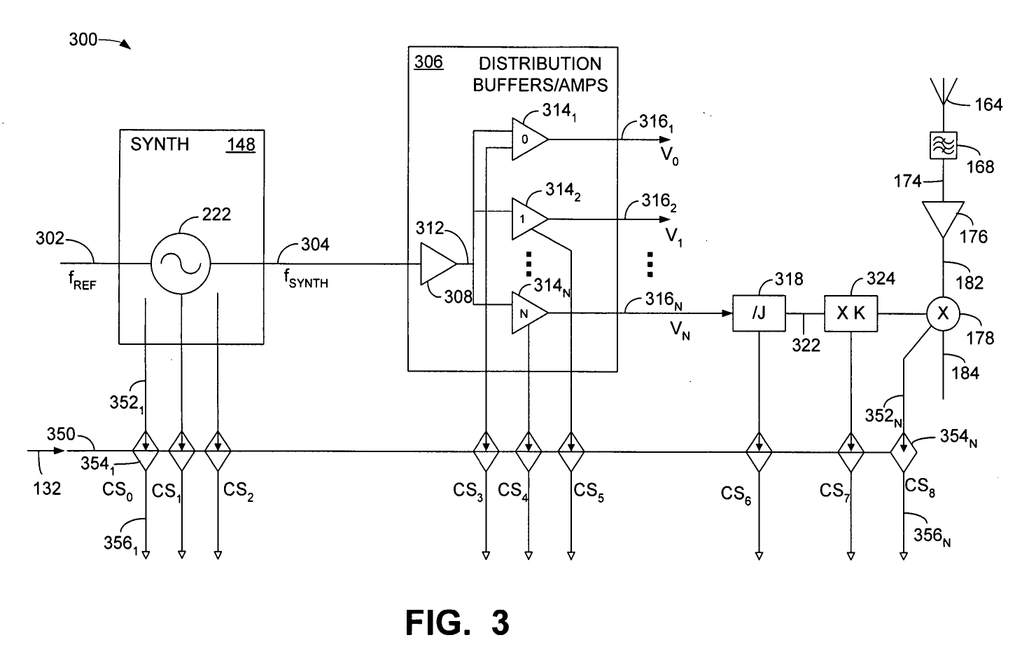

FIG. 3 is a block diagram illustrating an embodiment of a bias control network used to control the bias signal supplied to various elements within the LO chain of a portable transceiver 100. The bias control network 300 includes a synthesizer 148, which includes an oscillator 222. The oscillator 222 develops the LO signal that is supplied to various elements in the portable transceiver 100. The bias control network 300 also includes a distribution element 306 including an amplifier 308 and a plurality of distribution amplifiers 314, through 314_{N}. A reference signal at a frequency fREF is supplied via connection 302 to the oscillator 222. The output of the oscillator 222 on connection 304 is a signal at the desired intermediate frequency (IF) or local oscillator (LO) frequency, and is referred to as f_{SYNTH}.

The LO signal on connection 304 is supplied to an amplifier 308, which supplies an output on connection 312 to each of the distribution amplifiers 314 in the distribution element 306. The output of each of the distribution amplifiers 314 is supplied to a different element, or elements, using the local oscillator signal. For example, in this embodiment, the output on connection 316, can be supplied to a first mixer (not shown), the output on connection 3162 can be supplied to a second mixer (not shown), and, in this example, the output on connection 316_{N} is supplied to a frequency divider 318. The frequency divider 318 divides the signal on connection 316_{N} by an integer number, J. The output of the frequency divider 318 is supplied via connection 322 to a frequency multiplier 324. The frequency multiplier 324 multiplies the signal on connection 322 by an integer number, K, resulting in the local oscillator signal supplied on connection 180 to the downconverter 178. The downconverter 178 is part of the receive chain, and receives the output of the LNA 176 via connection 182. As described above, the output of the down converter 178 is supplied via connection 184 to the filter 186 (FIG. 1) and the other elements in the receive chain. Alternatively, the LO signal may also be supplied to an element, or elements, in the transmit chain.

In accordance with an embodiment of the invention, a bias bus 350, which is coupled to, and receives control signals from the connection 132 (FIG. 1), comprises one or more current sources, abbreviated as CS_{0-N} and referred to using reference numerals 354, through 354_{N}. The current sources CS_{N} are referred to as dependent current sources that can either have discrete states or that can be continuously variable. Alternatively, voltage sources may be used instead of current sources. One or more current sources 354_{N} are coupled to respective elements within the LO chain, including synthesizer 148, the distribution element 306, the frequency divider 318, the frequency multiplier 324 and the down converter 178. The connections 352_{N}, corresponding to each of the current sources 354_{N}, denote that each current source 354_{N} controls a respective power consuming element within the bias control network 300.

In this example, the bias bus 350 may be implemented as an analog control signal to control the current drawn by the current sources 354. Alternatively, the bias bus 350 may be used to address the current sources 354 to set each bias associated with each current source 354, either individually or collectively. For example, the bias bus 350 can be implemented as a three conductor address bus which can alter the current in each of the current sources 354 individually to determine the amount of current consumed for each component coupled to each current source. Alternatively, the bias bus 350 can be controlled to universally alter the current in all of the components in the bias control network 300. The input to the bias bus 350 can be received from a decoder (not shown) contained within, or coupled to, the LO power control element 204, and which determines the amount of current drawn by each of the elements in the LO chain, depending on the level of the RSSI signal described above, or according to a control program executed by the LO control program 310 (FIG. 1). The power consumption of the elements in the LO chain is controlled based on the RSSI signal and on the noise parameters of the receiver, as mentioned above, to provide an adequate signal-to-noise ratio in the receiver using minimal bias power.

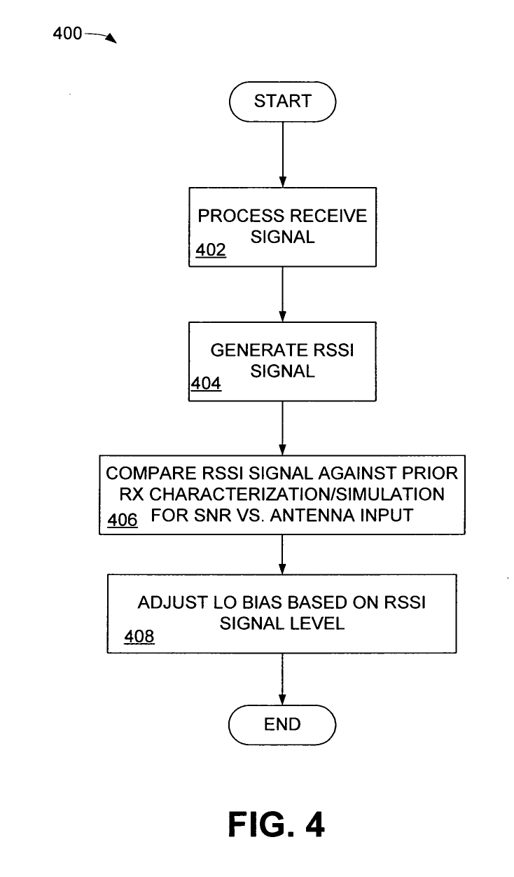

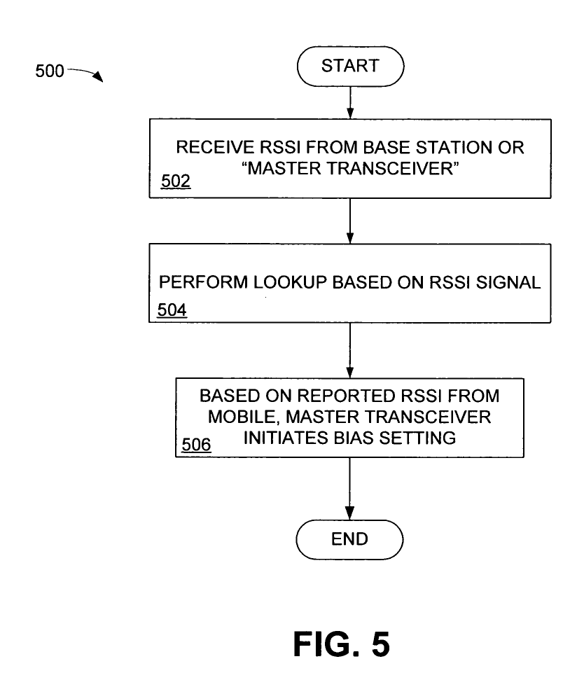

FIG. 4 is a flow chart illustrating the operation of one embodiment of the system for reducing LO power consumption. The blocks in the flow charts of FIGS. 4 and 5 can be performed in the order shown, out of the order shown, or can be performed substantially in parallel. In block 402, a received signal is processed and supplied to the RSSI element 208. In block 404, the RSSI element 208 generates an RSSI signal. In block 406, the RSSI signal is compared against prior received characterization/simulation information for signal-to-noise ratio versus antenna input, under various LO phase noise bias control. In block 408, the LO power control element 204 outputs a signal onto the bias bus 350 based on the logic used to partition the signal-to-noise ratio versus antenna input for various phase noise settings. In this manner, the power consumed by the components in the LO chain can be minimized, while ensuring an adequate signal-to-noise ratio in the receiver.

FIG. 5 is a flow chart illustrating the operation of an alternative embodiment of the system for reducing LO power consumption. In block 502, a command is received from a base station, or a master transceiver. The command reflects information generated by the base station master transceiver using information in the mobile unit's RSSI signal. In block 504, the LO control program 310 (FIG. 1) performs a lookup using the signal received from the base station to determine the appropriate bias setting. In block 506, based on the reported RSSI signal from the mobile unit, the master transceiver indicates the desired bias setting, and commands the LO power control element 204 to place the appropriate signal on the bias bus 350 (FIG. 3).

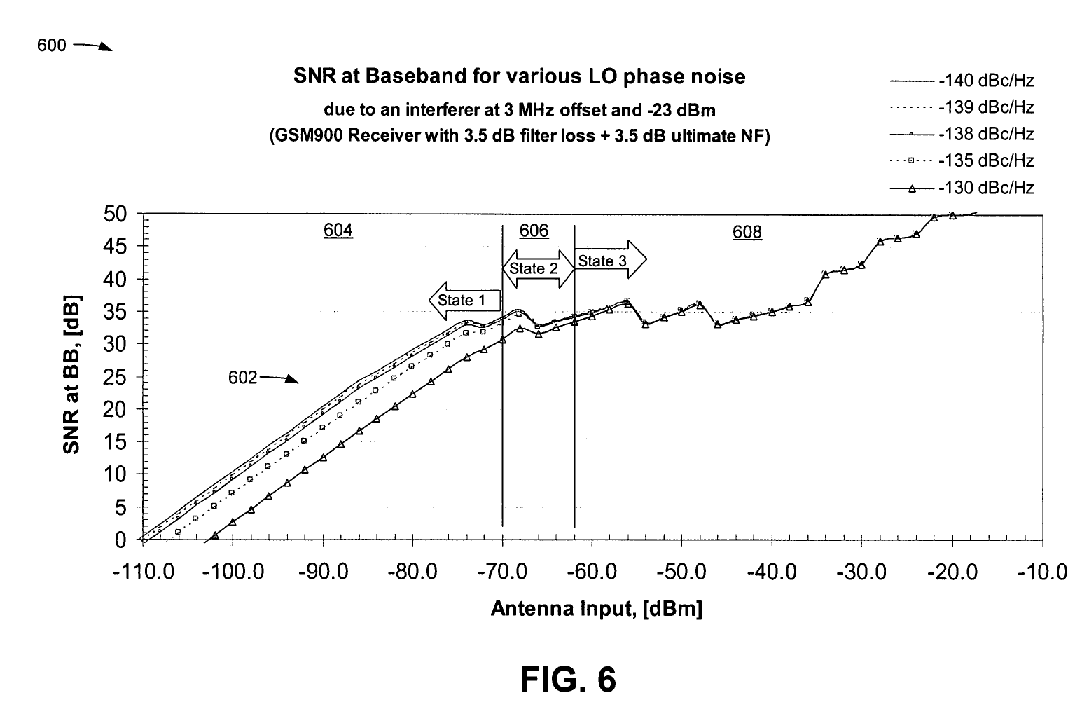

FIG. 6 is a graphical illustration showing three exemplary operating states for the LO 222. The vertical axis represents signal-to-noise ratio (SNR) in dB at baseband, while the horizontal axis indicates received signal strength as antenna input level, in dBm. The trace 602 is divided into three operational states. Three operational states are selected merely for simplicity of explanation. Fewer or additional operating states can be implemented within the scope of the system for reducing LO power consumption. A first portion 604 of the curve 602 indicates a first operating state in which the antenna input is at a relatively low to moderate level. When operating in the first operational state, the phase noise in the LO contributes significant interference to the received signal, resulting in a relatively low SNR in the LO. Accordingly, it is desirable to maximize the performance of the LO by increasing the amount of power supplied to the LO to overcome the relatively low input signal level. In this example, the cut-off point of operational state one (1) is at approximately −70 dBm with a signal to noise ratio of approximately 30 dBc/Hz. The portion 606 of the curve 602 indicates a second operational state in which the power supplied to the LO 222 may be reduced due to the improved SNR in the LO, resulting from the increase input signal power level. A third portion 608 of the curve 602 indicates a third operational state in which the input to the antenna is approximately −55 dBm or greater and in which the SNR ratio presented to the demodulator is generally above 30 dB. In the third operational state, the power to the LO 222 can be set to a minimum, without signal degradation due to phase noise in the LO.

The 3 MHz offset is used as an example. Various offsets may be characterized or deemed important by a particular communication channel/scheme., and the invention is intended to cover those instances as well. The phase noise contribution of various subsystem blocks is in general dependent on the circuitry and architecture, so the bias control current sources may be chosen to operate only on those subsystem blocks or components determined as dominate contributors.

While various embodiments of the invention have been described, it will be apparent to those of ordinary skill in the art that many more embodiments and implementations are possible that are within the scope of this invention. Accordingly, the invention is not to be restricted except in light of the following claims and their equivalents.

What is claimed is:

1. A local oscillator (LO) chain bias control system, comprising:
means for adjusting a bias control signal to a local oscillator (LO) depending on a noise parameter of the local oscillator.

2. The LO chain bias control system of claim 1, wherein the noise parameter is dependent upon a strength of a receive signal.

3. The LO chain bias control system of claim 2, further comprising:
means for increasing a level of the bias control system when the receive signal weakens.

4. The LO chain bias control system of claim 2, further comprising:
means for decreasing a level of the bias control system when the receive signal strengthens.

5. The LO chain bias control system of claim 2, wherein the means for adjusting a bias control signal to a local oscillator (LO) further comprises means for detecting a power level of the receive signal.

6. The LO chain bias control system of claim 5, wherein the means for adjusting a bias control signal to a local oscillator (LO) means is responsive to the detected power level of the receive signal.

7. The LO chain bias control system of claim 1, wherein the means for adjusting a bias control signal to a local oscillator (LO) further comprises means for determining the level of the LO bias control signal according to a baseband LO power control element.

8. The LO chain bias control system of claim 7, wherein the means for adjusting a bias control signal to a local oscillator (LO) means is responsive to the baseband LO power control element.

9. A method for controlling the bias power supplied to a local oscillator (LO) chain, comprising:
adjusting a bias control signal to a local oscillator (LO) depending on a noise parameter of the local oscillator.

10. The method of claim 9, wherein the noise parameter is dependent upon a strength of a receive signal.

11. The method of claim 10, further comprising increasing a level of the bias control system when the receive signal weakens.

12. The method of claim 10, further comprising decreasing a level of the bias control system when the receive signal strengthens.

13. The method of claim 10, further comprising detecting a power level of the receive signal.

14. The method of claim 13, wherein the adjusting a bias control signal to a local oscillator (LO) is responsive to a detected power level of the receive signal.

15. The method of claim 9, further comprising determining the level of the LO bias control signal using a baseband LO power control element.

16. The method of claim 15, further comprising adjusting a bias control signal to a local oscillator (LO) according to the baseband LO power control element.

17. A system for controlling the bias power supplied to a local oscillator (LO) chain located in a portable communication device, comprising:
a portable communication device including a transmitter and a receiver;
a receive signal strength determination element located in the receiver; and
an LO power control element responsive to the receive signal strength determination element, the LO power control element configured to supply a bias control signal to a local oscillator, the bias control signal level determined by the relative signal strength of the receive signal.

18. The system of claim 17, wherein the bias control signal level is increased when the receive signal weakens.

19. The system of claim 17, wherein the bias control signal level is decreased when the receive signal strengthens.

20. The system of claim 19, wherein the bias control signal level is decreased when the relative signal strength of the receive signal reaches a predetermined level.

21. The system of claim 20, wherein the bias control signal level is decreased when the relative signal strength of the receive signal reaches −70 dBm.

22. A local oscillator (LO) controller, comprising an LO power control element responsive to a receive signal strength determination element, the LO power control element configured to supply a bias control signal to a local oscillator, the bias control signal level determined by the relative strength of the receive signal.
